(19) United States
(12) Patent Application Publication
(10) Pub. No.: US 2010/0255289 A1
(43) Pub. Date: Oct. 7, 2010

(54) Aluminosilicate-Based Oxide Composite Coating and Bond Coat for Silicon-Based Ceramic Substrates

(76) Inventors: Charles Lewinsohn, Salt Lake City, UT (US); Qiang Zhao, Natick, MA (US); Balakrishnan G. Nair, Sandy, UT (US)

Correspondence Address: CERAMATEC, INC., 2425 SOUTH 900 WEST, SALT LAKE CITY, UT, 84119, US

(21) Appl. No.: 11/626,804

(22) Filed: Jan. 24, 2007

Related U.S. Application Data
(60) Provisional application No. 60/762,351, filed on Jan. 25, 2006.

(51) Int. Cl. B32B 18/00; B32B 5/16; B05D 3/02; C08L 83/00

(52) U.S. Cl. 428/325; 428/446; 427/226; 524/588

(57) ABSTRACT

An article is disclosed in one embodiment of the invention as including a silicon-based ceramic substrate and a top coat. A bond coat is provided between the silicon-based ceramic substrate and the top coat. The bond coat is derived from a mixture containing preceramic polymer precursors, such as polycarbosilanes, polycarbosilazanes, or other silicocarbon polymers and pyrolyzed preceramic polymer precursors. A filler material may also be included in the mixture to modify the coefficient of thermal expansion (CTE) of the bond coat to more closely match the CTE of the silicon-based ceramic substrate, top coat, or both.

### RELATED APPLICATIONS

This application claims priority to U.S. Provisional Patent No. 60/762,351 filed on Jan. 25, 2006 and entitled ENVIRONMENTAL BARRIER COATINGS.

### GOVERNMENT RIGHTS

This invention was made in part with government support under Grant No.: DE-AC05-00OR22725 awarded by the United States Department of Energy. The Government has certain rights in the invention.

### BACKGROUND OF THE INVENTION

1. Field of the Invention

This invention relates to coatings for ceramic materials and more particularly to environmental barrier coatings for silicon-based ceramic substrates.

2. Description of the Related Art

For the last several decades, researchers have worked to develop ceramic materials for use in gas turbine and other high temperature components. A transition from current nickel-based superalloy materials to ceramics has the potential to increase the operating temperature of turbines by more than 200° C., up to potential operating temperatures of 1400° C. or more. Use of ceramics in gas turbines has the potential to improve performance, augment a turbine's life span, reduce fuel consumption, and reduce harmful exhaust emissions.

Silicon nitride based monolithic ceramics (Si₃N₄) and silicon carbide based Continuous Fiber Ceramic Composites (SiC/SiC CMCs) are currently the most promising candidate materials for gas turbine applications. These materials show more promise than many other ceramics at least in part because of their low thermal expansion, high strength, and moderate thermal conductivity. However, these materials are also rapidly corroded by high temperature water vapor, a significant product of combustion, due to volatilization of silica scale on the substrate surface as expressed, for example, by the following reaction:

SiO₂(s)+2H₂O(g)→Si(OH)₄(g)

In order to solve this problem, there are two basic approaches. The first approach is to develop a ceramic matrix composite (CMC) with intrinsic resistance to water vapor corrosion. The other approach is to apply an environmental barrier coating (EBC) to the silicon-based ceramic substrate to improve its resistance to water vapor corrosion. Both approaches require identification of a hydrothermally stable material that is resistant to corrosion resulting from high-temperature water vapor. Once identified, this material may be used as a top coat on a silicon-based ceramic substrate or be included in the matrix of a CMC.

In the past, materials such as mullite, yttria stabilized zirconia (YSZ), barium strontium aluminosilicates (BSAS), and lutetium silicates (Lu₂Si₂O₇) have been studied and tested as top coat materials for EBC applications. However, there are various drawbacks associated with these materials, including, for example, instability at high-temperatures, coefficients of thermal expansion (CTE) that are too large for the underlying substrate, raw materials that are too expensive, properties or application methods that cause recession of the substrate, or the like. Thus, there is still a significant need for hydrothermally stable materials that can be applied as a top coat in an EBC system.

Furthermore, suitable bond coats or intermediate layers may be needed to successfully apply a top coat to a silicon-based ceramic substrate. In some cases, a coating that is effective to reduce corrosion may not adhere well to a substrate due to various property mismatches (e.g., differences in coefficients of thermal expansion) between the coating and the substrate. In some cases, a bond coat may be required to provide adequate adhesion. Nevertheless, bond coats or other intermediate layers used to compensate for property mismatches, as well as methods for applying the bond coats, may need to meet stringent requirements. For example, materials used for the bond coat must normally adhere well to both top coat and substrate materials, have good high-temperature stability, not exhibit any deleterious reactions with either the top coat or substrate, and have acceptable thermoelastic properties.

In view of the foregoing, what is needed is an improved top coat for silicon-based ceramic substrates that is environmentally stable under turbine operating conditions, is able to prevent or greatly reduce the permeation of corrosive gases to the substrate, and possesses acceptable thermoelastic properties to be compatible with the substrate. Further needed is a bond coat that adheres well to both top coat and substrate materials, has good high-temperature stability, does not deleteriously react with the top coat or the substrate, and has acceptable thermoelastic properties. Such a top coat and bond coat would be useful not only in turbines and power generation applications, but also in aviation and other applications requiring EBCs.

### SUMMARY OF THE INVENTION

The present invention has been developed in response to the present state of the art, and in particular, in response to the problems and needs in the art that have not yet been fully solved by currently available environmental barrier coatings. Consistent with the foregoing and in accordance with the invention as embodied and broadly described herein, an article is disclosed in one embodiment of the invention as including a silicon-based ceramic substrate and a top coat. A bond coat is provided between the silicon-based ceramic substrate and the top coat. The bond coat is formed from a mixture containing a preceramic polymer precursor and a pyrolyzed preceramic polymer precursor. A filler material may also be included in the mixture to modify the coefficient of thermal expansion (CTE) of the bond coat to more closely match the CTE of the silicon-based ceramic substrate, top coat, or both.

In selected embodiments, suitable preceramic polymer precursors may include, for example, polycarbosilanes, polycarbosilazanes, or other silicocarbon polymers. Similarly, in selected embodiments, the preceramic polymer precursor is a liquid and the pyrolyzed preceramic polymer precursor is a solid. The pyrolyzed preceramic polymer precursor may, in certain embodiments, be milled to produce a powder with an average particle size of less than five microns.

In certain embodiments, the bond coat mixture may further include an inert filler. This inert filler may include, for example, the same material as the silicon-based ceramic substrate to promote adhesion to the silicon-based ceramic substrate, the same material as the top coat to promote adhesion to the top coat, or both. The inert filler may also reduce shrinkage of the bond coat. In other embodiments, the mixture may include an active filler material to react with the preceramic polymer precursor and pyrolyzed preceramic polymer precursor. This active filler may, upon reaction with the preceramic polymer precursors, increase the volume of the bond coat material to prevent cracking and reduce the porosity of the bond coat. Suitable active fillers may include, for example, TiSi₂, TiH₂, Fe, Al, Ni, or the like.

In another aspect of the invention, a bond coat slurry for producing a bond coat in accordance with the invention may include a mixture of polymer preceramic precursors and pyrolyzed polymer preceramic precursors. A filler material may be added to the mixture to adjust the coefficient of thermal expansion of a bond coat produced from the bond coat slurry to more closely match that of a top coat or substrate.

Suitable preceramic polymer precursors for inclusion in the slurry may include, for example, polycarbosilanes, polycarbosilazanes, or other silicocarbon polymers. Similarly, in certain embodiments, the preceramic polymer precursor may be provided in liquid form whereas the pyrolyzed preceramic polymer precursor may be provided in solid form. This solid may, in certain embodiments, be milled to produce a powder with an average particle size of less than five microns.

In certain embodiments, the slurry may include an inert filler to promote adhesion to the silicon-based ceramic substrate, the top coat, or both, or to reduce shrinkage of the bond coat. The slurry may also include an active filler material to react with the preceramic polymer precursor and pyrolyzed preceramic polymer precursor. This active filler may increase the volume of the bond coat and may include, for example, TiSi₂, TiH₂, Fe, Al, Ni, or the like. In other embodiments, solvents and organic additives may be added to the slurry to control the slurry's rheology.

In another aspect of the invention, a method for applying a bond coat of an environmental barrier coating to a silicon-based ceramic substrate may include preparing a bond coat slurry. This bond coat slurry may contain polymer preceramic precursors and pyrolyzed polymer preceramic precursors. The silicon-based ceramic substrate may then be wetted with the bond coat slurry. The bond coat slurry may then be pyrolyzed to create a bond coat on the silicon-based ceramic substrate.

In selected embodiments, the method may further include wetting the bond coat with a top coat slurry. The top coat slurry may then be sintered to create a top coat on the bond coat. In selected embodiments, sintering may include heating to a temperature above 1200° C. Similarly, pyrolyzing may include heating to a temperature below 1200° C. Thus, pyrolysis of the bond coat may be performed at temperatures lower than those required to sinter the top coat.

In certain embodiments, wetting the underlying substrate with either the bond coat slurry or top coat slurry may include dip coating, spraying, painting, screen printing, or spin coating the underlying substrate with the bond coat or top coat slurry.

The present invention relates to articles and methods for creating hydrothermally stable environmental barrier coatings. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1A is a high-level cutaway profile view of one embodiment of an environmental barrier coating having a top coat and a single bond coat deposited on a silicon-based ceramic substrate;

FIG. 1B is a high-level cutaway profile view of one embodiment of an environmental barrier coating having a top coat and multiple bond coats deposited on a silicon-based ceramic substrate;

FIG. 2 is a flow diagram of one embodiment of a process for creating a slip to produce a bond coat in accordance with the invention;

FIG. 3 is a flow diagram of one embodiment of a process for creating an environmental barrier coating in accordance with the invention on a silicon-based ceramic substrate;

FIGS. 4A and 4B are several magnified cutaway profile views of one embodiment of an environmental barrier coating in accordance with the invention on a silicon-based ceramic substrate;

FIG. 5 is a magnified cutaway profile view of one embodiment of an environmental barrier coating using multiple bond coats;

FIG. 6 is a phase diagram showing various compositions in a CaO—SiO₂—Al₂O₃ system for use in a top coat in accordance with the invention;

FIG. 7 is a flow diagram showing one embodiment of a method for synthesizing various hydrothermally stable compositions from the components of the CaO—SiO₂—Al₂O₃ system; and

FIG. 8 is a graph showing the weight change of sintered calcium aluminosilicates after 2000 hours of hydrothermal testing in a high temperature tube furnace at 1200° C.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of the embodiments of articles and methods in accordance with the present invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

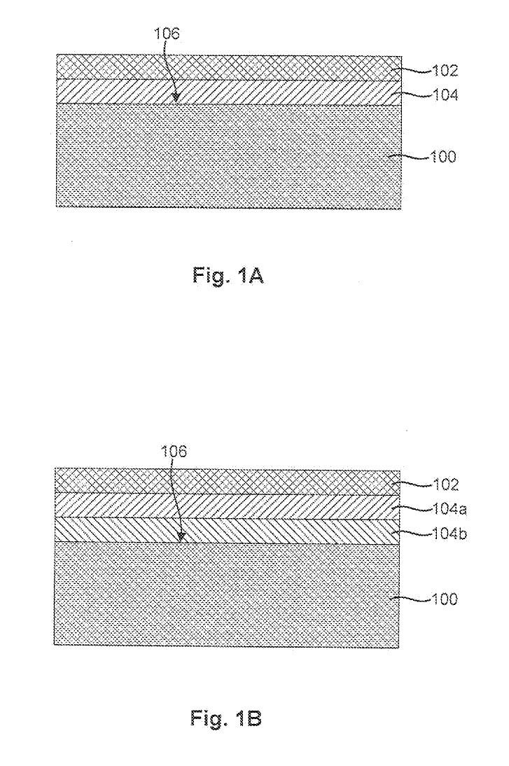

Referring generally to FIGS. 1A and 1B, the lifetime of many components 100 (represented generally by the substrate 100) used in important commercial applications may be limited by corrosion or erosion caused by the component's environment. In certain cases, these conditions may be mitigated by applying a coating 102 to cover and protect the substrate 100. Many coating materials, however, may not adequately adhere to various substrates 100. In such cases, a bond coat 104 may be used between the coating 102 and the substrate 100 to provide adequate adhesion therebetween.

For example, use of silicon-based ceramic in turbine engine applications may be limited by hydrothermal corrosion. Some materials with adequate resistance to hydrothermal corrosion may not possess the required mechanical properties to be used as engine components, but may nevertheless perform satisfactorily as coatings 102. Many of these materials, however, may be unsuitable for use as coatings 102 because of significant property mismatches with the substrate material 100. As a result, bond coats 104 or other intermediate layers 104 may be used to accommodate property mismatches. The intermediate layers 104 and methods of applying them, however, must often meet stringent requirements to adequately perform their function.

Silicon-based ceramics and composites, such as silicon carbide (SiC), silicon nitride (Si₃N₄), silicon carbide matrix composites, silicon nitride matrix composites, or the like, have the high temperature thermomechanical properties needed for use in gas turbine engine hot-section components and sensors, such as turbine blades, disks, and rotors. These materials are stable under purely oxidizing conditions due to the formation of passivating oxide layers of silica scale. They may be significantly corroded, however, by H₂O and CO, which are commonly encountered in gas turbine systems. At high temperatures, in mixed oxidizing/reducing gas environments, the silica scale may be reduced to form the volatile gas species SiO(g) as indicated, for example, by the following reactions:

SiO₂+H₂(g)=SiO(g)+H₂O(g) (1)

SiO₂+CO(g)=SiO(g)+CO₂(g) (2)

In environments containing water vapor, volatile hydroxides or oxyhydroxides can form as indicated by the following reactions:

SiO₂+H₂O(g)=SiO(OH)₂(g) (3)

SiO₂+2H₂O(g)=SiO(OH)₄(g) (4)

SiO₂+½H₂O(g)=SiO(OH)(g)+¼O₂(g) (5)

The volatile species are removed continuously from the surface resulting in no passivation and continuous recession of the substrate. Corrosion of silicon nitride in the presence of water has also been observed. Furthermore, in silicon carbide- or silicon nitride-matrix, fiber-reinforced composites, oxidation of both the matrix and the interphase material degrades the mechanical performance of the materials. This corrosion problem may be mitigated through the use of dense coatings 102 that are themselves environmentally stable under turbine operating conditions and prevent the permeation of corrosive gases to the silicon-based ceramic component surface 106.

Materials that exhibit good hydrothermal corrosion resistance typically have much higher coefficients of thermal expansion than silicon nitride, or mismatched elastic properties, such that unacceptably high residual stresses develop in the substrate 100 or coating 102 that subsequently lead to failure after processing or during operation. One approach to mitigate these residual stresses is to insert layers 104 with intermediate properties between the coating 102 and the substrate 100. The choice of interlayer material 104, however, is limited by the requirements that it adheres to both top coat 102 and substrate materials 100, have good high-temperature stability, does not exhibit any deleterious reactions with either the top coat 102 or substrate 100, and has acceptable thermoelastic properties.

In certain embodiments in accordance with the invention, amorphous, non-oxide ceramics derived from preceramic polymers (polymer-derived ceramics, PDC) may be used to produce effective bond coats 104 between the top coat 102 and substrate 100. These materials demonstrate remarkable oxidation stability, low silica activity, and good mechanical properties at elevated temperatures. Furthermore, these materials show excellent adherence to a wide range of materials, including non-oxide ceramics, oxide ceramics, and metals. Thus, the bond coat materials 104 disclosed herein may be applied to many substrate materials 100 including lightweight oxide materials, silicon-based ceramic materials, or other materials susceptible to hydrothermal corrosion.

The PDC materials disclosed herein are stable well above their processing temperatures. Filler materials may also be incorporated into the PDC materials to tailor the properties of the PDC materials. Although ceramics derived from preceramic polymers demonstrate remarkable oxidation stability (similar to CVD-derived materials of the same compositions) and mechanical properties, the mechanisms of oxidation and corrosion for these materials are likely similar to those of other silicon-based ceramics. Thus, notwithstanding reports from various sources that the oxidation kinetics of these materials are extremely slow, the hydrothermal corrosion resistance of PDC materials, by themselves, may not be adequate for turbine engine environments. Nevertheless, the PDC materials disclosed herein will likely satisfy the stability requirements for bond coats where gas flow rates are low.

PDC materials offer the potential of providing adherent materials with graded properties to act as an interlayer 104 between advanced materials (i.e., substrates 100) and corrosion resistant coatings 102. In certain embodiments, fillers may be used to change the coefficient of thermal expansion (CTE) of PDC materials to match the CTE of other materials. For example, Table I below shows that the CTE of various PCD materials may be modified by the addition of fillers to more closely match the CTE of a substrate, in this example 8 mol % yttria-stabilized zirconia.

TABLE I
CTE Values for PDC/Filler Systems

| | Temperature | CTE |
|---|---|---|
| Composition | Range (° C.) | (ppm ° C.⁻¹) |
| 8 mol % yttria-doped zirconia | 25-1000 | 10.6-11.1 |
| polycarbosilane/Metal 1 | 200-700 | 10.0 |
| polycarbosilane/Metal 2 | 200-700 | 7.0 |
| polycarbosilane/Metal 3 | 200-700 | 9.0 |
| polycarbosilazane/Metal 1 | 200-600 | 10.0 |
| polycarbosilazane/Metal 2 | 200-700 | 5.0 |
| polycarbosilazane/Metal 3 | 200-700 | 10 |

The incorporation of filler materials into PDCs is an innovative means to obtain mechanically robust, dense, chemically stable interlayer materials 104 capable of adhering well to relevant substrates 100, possessing excellent stability at high temperatures, a low potential to react deleteriously with substrate 100 or top coat materials 102, and tailorable thermoelastic properties. In certain embodiments, liquid preceramic polymer precursors and solid pyrolyzed or partially pyrolyzed preceramic polymer precursors may be incorporated into a slip used to spray or dip coat a substrate 100. The bond coat 104 properties may be tailored by incorporating filler materials into the slip and a homogeneous composition may be prepared easily. Pyrolysis of the preceramic polymer precursors produces amorphous, non-oxide material that does not require the use of sintering aids that can deleteriously affect oxidation resistance.

It has been shown that application of PDC coatings containing silicon nitride powder as a filler material does not significantly decrease the strength of machined silicon nitride bend bars tested in four point bending. Furthermore, cross-hatch, adhesive tape peel tests, similar to ASTM D3359 Method A, have been used to demonstrate good adhesion of the bond coat 104 to the substrate 100. The bond coats 104 have also demonstrated good adhesion to other, relevant, outer coating materials 102 such as mullite and ytterbium silicate.

Furthermore, the bond coats 104 have exhibited good adhesion to both substrates 100 and outer coatings 102 after thermal cycle testing at 1300° C. in an environment of 90% H₂O, 10% O₂ flowing at 2.2 cm/sec. The thermal cycles were performed by shuttling the specimens in and out of a hot zone of a furnace held at 1300° C. The specimens were cycled between room temperature and 1300° C. with a heating time of 20 seconds to temperature, a 1 hour hold at 1300° C., a cooling time of several minutes, and a 20 minute hold at room temperature.

In selected embodiments, boron (B) or other materials may be added to the preceramic polymers to stabilize the bond coat 104 at higher temperatures. Studies have shown that addition of boron (B) to silicon carbide or silicon nitride based ceramics resulted in a material that did not decompose internally when exposed to temperatures as high as 1700° C. (unlike ceramic grade Nicalon fibers at elevated temperatures). This improved thermal stability is attributed to the formation of boron containing phases that stabilize the amorphous state at higher temperatures by reducing the activity of carbon and increasing the local nitrogen pressure. Thus, in certain embodiments, boron, or boron containing additives (e.g., TiB₂ or B₄C) may be incorporated into the bond coat slip.

In selected embodiments, multiple graded bond coats 104a, 104b or intermediate coats 104a, 104b may be used to reduce stresses between the top coat 102 and substrate 100, as illustrated in FIG. 1B. By varying the amount of filler materials, and hence properties, of each of the intermediate coats 104a, 104b the gradient of the property mismatch between the top coat 102 and substrate 100 may be reduced. By reducing the gradient of the property mismatch, stresses between the top coat 102 and substrate 100 may be reduced as well.

The ability to use multiple layers 104a, 104b to reduce the property gradient between the top coat 102 and substrate 100 may enable use of top coat materials that would not otherwise be considered. For example, magnesium aluminospinel (MgAl₂O₄), zircon (ZrSiO₄), and the cubic form of zirconium oxide (ZrO₂) show good resistance to hydrothermal corrosion. These materials, however, exhibit large thermal expansion mismatches relative to silicon nitride and, therefore, have not been considered as candidate top coats 102 for silicon nitride substrates 100. Using multiple bond coat layers 104a, 104b with graded properties, however, stresses may be reduced sufficiently to make these materials candidates for use as top coats 102.

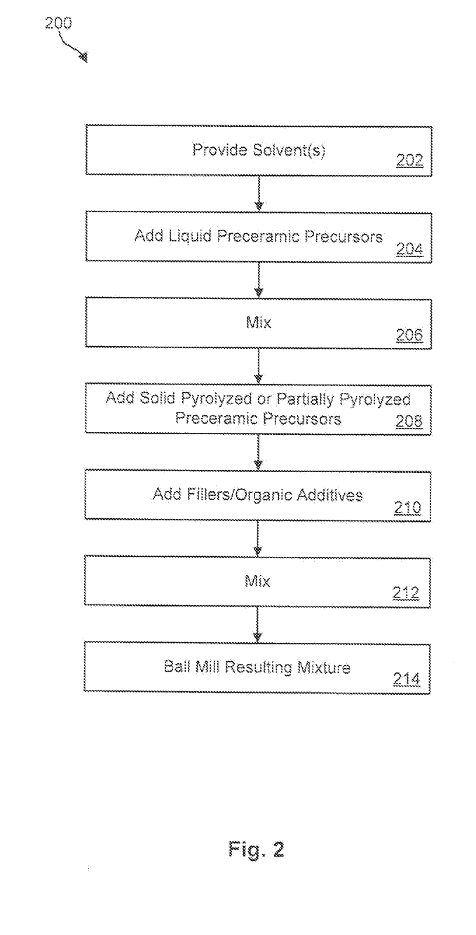

Referring to FIG. 2, one embodiment of a method 200 for producing a bond-coat slip in accordance with the invention may include providing one or more solvents (e.g., toluene, acetone, methyl ethyl ketone (MEK), etc.) and adding 204 liquid preceramic polymer precursors to the solvents. Suitable liquid preceramic precursors may include, for example, (poly)carbosilanes, such as allyl hydridopolycarbosilane (e.g., aHPCS from Starfire Systems, Inc.) and (poly)carbosilazanes (e.g., KiON VL-20 from Kion, Inc.), although other precursor ceramic materials (i.e., silicocarbon polymers) may also be incorporated into the slip. The solvents and liquid precursors may then be mixed 206.

Once mixed, solid pyrolyzed or solid partially pyrolyzed preceramic precursors (e.g., pyrolyzed aHPCS) may be added 208 to the mixture. The pyrolyzed precursors may be added to reduce shrinkage of the liquid precursors in the slip and thereby reduce stresses in the coating 104 when the remaining liquid preceramic precursors are pyrolyzed and the coating 104 is sintered. This may reduce or prevent cracks from forming in the coating 104. This may also allow the coating 104 to achieve a greater density with less shrinkage. In certain embodiments, the pyrolyzed or partially pyrolyzed precursors may be milled after pyrolysis (but before addition to the mixture) such that the average particle size is less than five microns. This may provide more uniform shrinkage of the bond coat 104.

Organic additives may be added 210 to control the rheology of the slip. As will be explained in more detail hereafter, the rheology may be important when applying (e.g., dip-coating, spraying, etc.) the slip to the substrate 100 in order to achieve a desired thickness for the coating 104 and thereby reduce the chance of cracking. Active, inert, or other fillers may also be added 210 to the slip. Inert fillers, such as SiC or Si₃N₄, may be added 210, for example, to control shrinkage of the coating 104 and reduce residual stresses in the coating 104. In certain embodiments, active fillers, such as TiSi₂, TiH₂, Fe, Al, Ni, or the like may also be added 210 to the slip to react with the preceramic precursors upon pyrolysis or sintering. In certain embodiments, this reaction may create compounds with greater volume to reduce shrinkage of the coating 104, strengthen the coating 104, or reduce the porosity of the coating 104 to make it more impermeable to gases or liquids.

Other filler materials may also be added 210 to the bond coat slip to modify the bond coat's coefficient of thermal expansion, oxidation resistance, erosion resistance, or the like. For example, materials such as Al₂O₃, ZrO₂, Fe, Cu, Ni, Mo, Al, Ti, TiH₂, TiSi₂C, MgO, or the like, may be added to the bond coat slip to modify the bond coat's coefficient of thermal expansion. Similarly, some filler materials may be added 210 to the bond coat slip to improve compatibility and adhesion of the bond coat 104 with the top coat 102 and substrate 100. For example, filler powder of the substrate material 100, filler powder of the top coat 102, or both may be added 210 to the bond coat slip to make the bond coat 104 adhere better to the top coat 102 or substrate 100.

Once all desired components are added to the slip, the slip may be mixed 212, to produce a homogeneous slip. If needed, the mixture may be processed 214 by a ball mill or other suitable milling device to reduce the particle size of components in the slip. It should be recognized some or all of the above-mentioned parameters, including inert filler type (e.g., SiC, Si₃N₄), active filler type (e.g., TiSi₂, TiH₂, Fe, Al, Ni), other filler types (e.g., Al₂O₃, ZrO₂, Fe, Cu, Ni, Mo, Al, Ti, TiH₂, TiSi₂C, MgO), filler volume fraction (e.g., 0.3, 0.5, 0.7), pyrolysis temperature (e.g., 1000° C., 1200° C.), and coating thickness (e.g., 100 μm, 200 μm, 500 μm), may be varied, as needed, to produce a bond coat 104 with desired properties.

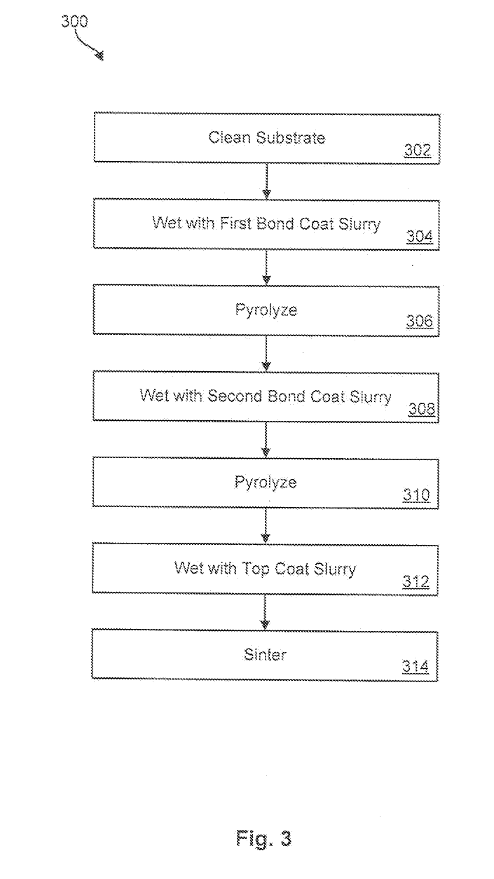

Referring to FIG. 3, one embodiment of a method 300 for applying a bond coat 104 and top coat 102 to a substrate 100 may include initially cleaning 302 or otherwise preparing 302a substrate 100. This step 302 may include simply cleaning 302 the substrate 100 (e.g., Si₃N₄) with acetone. The substrate 100 may then be wetted 304 with a first bond coat slurry. This wetting step 304 may include, for example, dip-coating, spraying, painting, screen printing, spin-coating, or other suitable methods for applying the slurry to the substrate 100 which will not degrade the substrate 100. Because of the liquid nature of the slurry, the slurry may be applied to the substrate 100 without using a line-of sight process (e.g., physical vapor deposition, chemical vapor deposition, etc.), facilitating application of the slurry to complex shapes.

After applying the bond coat slurry to the substrate 100, the coated substrate may then be heated to a temperature between about 900° C. and 1200° C. to pyrolyze 306 the coating materials, adhere the coating 104 to the substrate, react active fillers in the coating 104, and densify the coating 104. Pyrolysis of the bond coat may be performed at temperatures significantly lower than those required to sinter the top coat (which may be performed at temperatures exceeding 1200° C.). In certain cases, these lower temperatures may reduce the chance of damaging the substrate, particularly when applying the bond coat to ceramic composites (e.g., SiC CMCs). In certain embodiments, the pyrolysis may be conducted in air, argon, or nitrogen atmospheres. Despite the relatively low processing temperatures required for producing covalent material from preceramic precursors, the resulting amorphous or nanocrystalline material is stable with respect to thermal decomposition at much higher temperatures.

Controlled heating rates may be required in the temperature range where volatile species evolve from the precursor ceramics. For example, volatile species may evolve in the temperature rage of 100° C. to 600° C. for (poly)carbosilane (e.g., aHPCS) as has been shown by conducting differential thermal analysis and thermal gravitational analysis (DTA/TGA). In order to develop coatings for silicon nitride, the parameters discussed above including filler type, filler content, pyrolysis temperature, and coating thickness are important process parameters that should be controlled carefully to obtain acceptable coatings.

If desired or needed, a second bond coat may be applied by wetting 308 the first bond coat with a second bond coat slurry of either a same or different composition. The second bond coat may then be pyrolyzed 310 as discussed above. This process may be repeated to apply additional bond coats 104 or intermediate layers 104 as needed. As disclosed herein, multiple bond coats may be applied to reduce the property gradient between the top coat 102 and substrate 100.

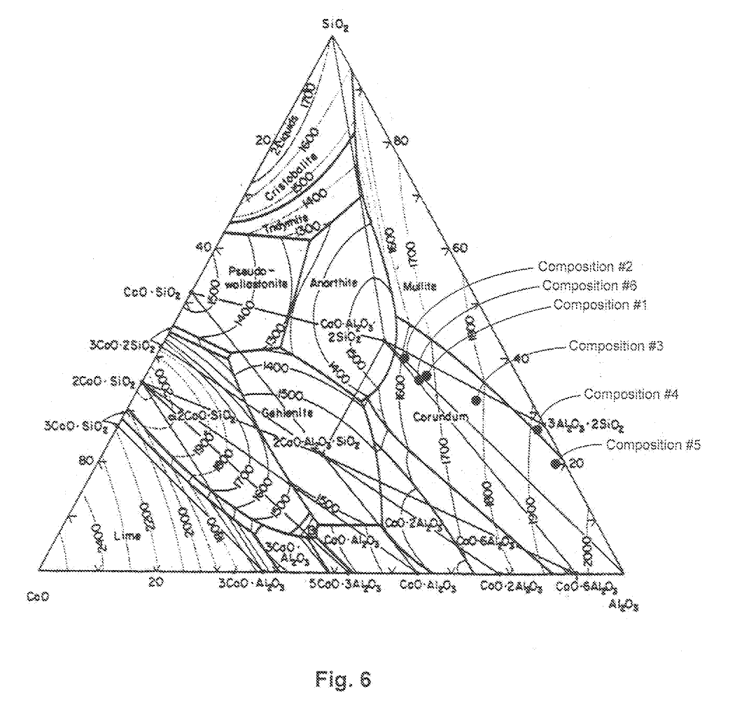

After applying one or more bond coats 104, the underlying substrate may be wetted 312 with a top coat slurry. Suitable top coat materials for inclusion in the top coat slurry may include, among others, ytterbium silicate (Yb₂Si₂O₇), lutetium silicate (Lu₂Si₂O₇), yttria-stabilized zirconia (8 mol % yttria+92 mol % ZrO₂, i.e., 8YSZ), strontium-stabilized celsian ((1−x)BaO-xSrO—AlO₂—SiO₂, 0<x<1), i.e., BSAS), mullite (3Al₂O₃-2SiO₂), or other materials resistant to hydrothermal corrosion or erosion. The top coat slurry may also include novel materials having low silica activity as discussed herein in association with FIGS. 6 through 8. The top coat 102 may then be sintered at a higher temperature (e.g., 1200-1350° C.) to adhere the coating 102 to the underlying substrate, react active fillers in the coating 102, and densify the coating 102. If desired, multiple top coat layers of either a same or different composition may be applied using the above-state process.

The bond coats and top coats may be applied, pyrolyzed, and sintered in any suitable order. For example, in certain embodiments, each bond coat may be applied and pyrolysed prior to applying the next bond coat or top coat. In other embodiments, multiple bond coats may be applied and pyrolysed simultaneously by applying heat concurrently. In other embodiments, both the bond coats and top coats may be applied initially. These coats may then be sintered together to pyrolyze the bond coats and sinter the top coat simultaneously. Thus, the pyrolysis and sintering steps may be ordered differently, as needed, and may in some cases be varied based on the application.

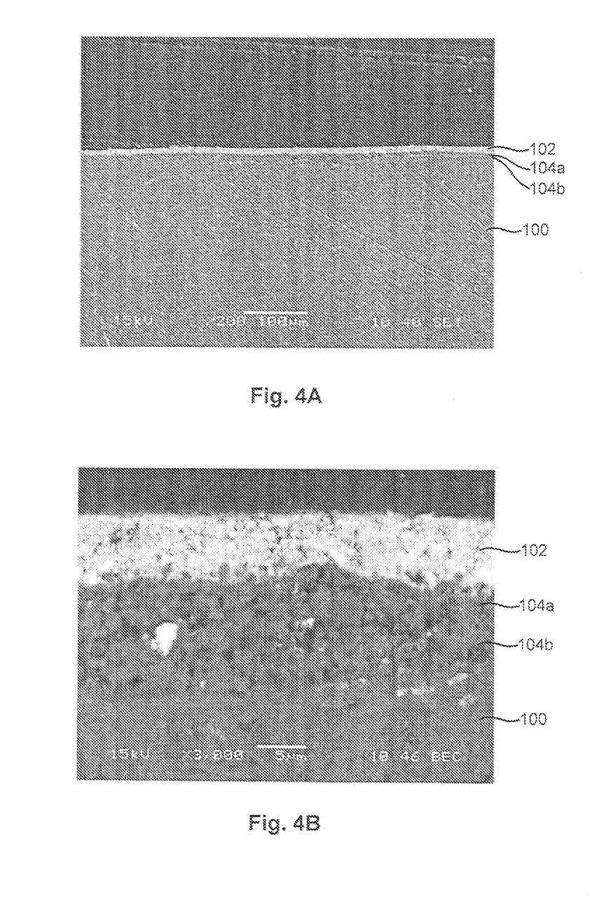

Referring to FIGS. 4A and 4B, several highly magnified images of substrates 100 coated with two bond coat layers 104a, 104b and an oxide-based top coat 102 using the methods 200, 300 illustrated in FIGS. 2 and 3 are illustrated. These coating are shown under different levels of magnification. As shown, a first bond coat 104a of PDC with 3 mol % yttria-stabilized zirconia filler, a second bond coat 104b of PDC with silicon nitride filler, and a top coat 102 of 3 mol % zirconia were applied to a silicon nitride substrate 100. Although 3 mol % zirconia is not known to have good hydrothermal corrosion resistance, the results demonstrate that these types of coatings may be applied to silicon nitride. Furthermore, the fact that thin layers were deposited may be beneficial to the achievement of graded coatings with small property gradients.

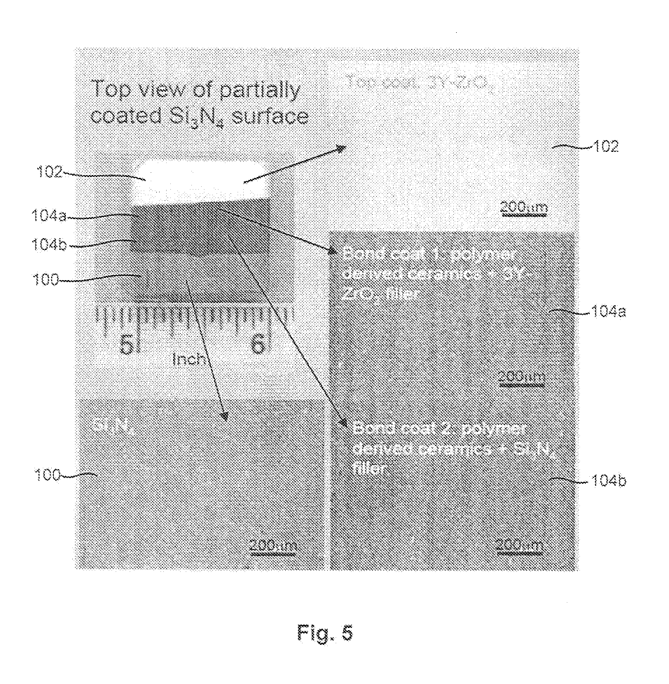

Referring to FIG. 5, another magnified image of a substrate 100 coated with two bond coat layers 104a, 104b and an oxide-based top coat 102 is illustrated.

Referring to FIG. 6, as mentioned, various materials such as mullite, yttria stabilized zirconia (YSZ), barium strontium aluminosilicates (BSAS), and lutetium silicates (Lu₂Si₂O₇) have been used as top coats 102 in EBC applications. However, these materials may be unstable at high-temperatures, have coefficients of thermal expansion (CTE) that are too large for the underlying substrate, contain raw materials that are too expensive, or have properties or application methods that cause recession of the substrate. Thus, there is still a significant need for hydrothermally stable materials that can be applied as top coats 102 in EBC systems.

In certain embodiments in accordance with the invention, an improved top coat 102 resistant to hydrothermal corrosion and erosion may be synthesized from one or more of various oxide powder compositions in the CaO—SiO2—Al2O3 system, as shown in FIG. 6. A starting powder mixture for each of the synthesized compositions is shown in Table II below:

TABLE II
Starting Powder Compositions for Synthesized
Calcium Aluminosilicates

| Compositions | 1 | 2 | 3 | 4 | 5 | 6 |
|---|---|---|---|---|---|---|
| CaO (wt %) | 17.56 | 18.74 | 8.74 | 1.33 | 1.33 | 18.44 |
| Al₂O₃ (wt %) | 42.81 | 39.26 | 57.04 | 71.11 | 78.67 | 42.98 |
| SiO₂ (wt %) | 39.63 | 42.00 | 34.22 | 27.56 | 20.00 | 38.58 |

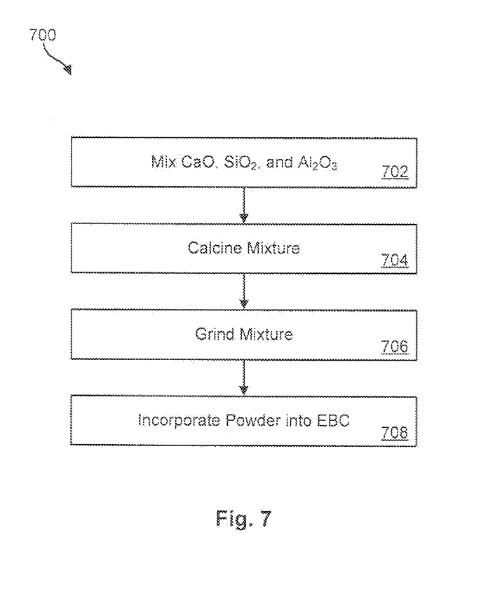

Referring to FIG. 7, one example of a method 700 for producing the synthesized top coat compositions listed in Table II include mixing 702 powders of CaO, SiO₂, and Al₂O₃ together. This may be achieved, for example, by mixing the components together with methanol and alumina media by ball milling. In the event ball milling is used, the method 700 may include ball milling the mixture for a prescribed period, such as 24 hours, drying the mixed powder (e.g., at room temperature), and sieving it such as through a #80 mesh screen. The resulting mixture may then be calcined 704 at an elevated temperature (e.g., 1350° C.) for a prescribed period (e.g., 8 hours).

The resulting calcined powder may then be ball milled 706 with methanol and alumina media for a prescribed period such as 48 hours to reduce the particle size. This powder may then be dried at room temperature and sieved through a screen such as a #80 mesh screen to remove larger particles. The resulting powder may then be incorporated 708 into a top coat of an EBC system or the matrix material of a ceramic matrix composite (CMC). Further particle size reduction may be necessary depending on different applications. One of ordinary skill in the art will recognize that various steps of the method 700 may be varied without significantly departing from the principles disclosed herein.

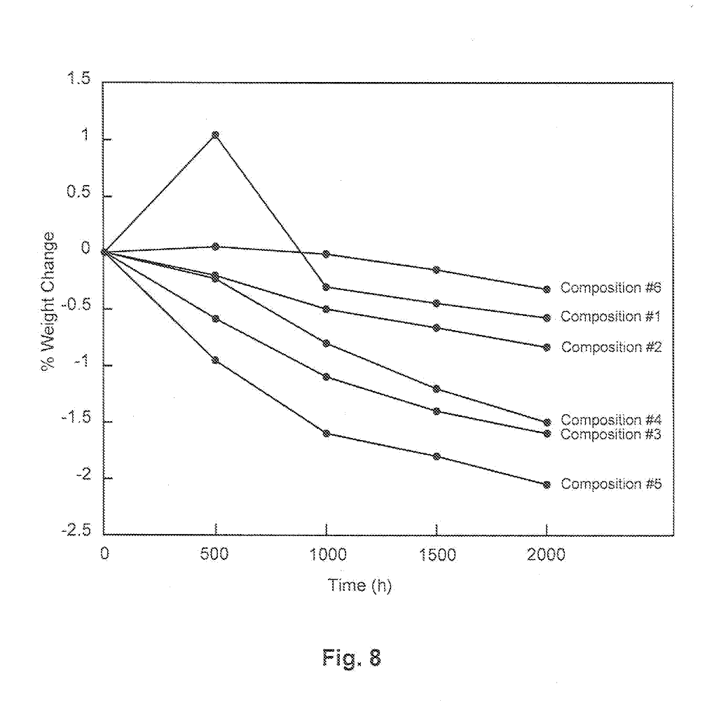

Referring to FIG. 8, to test the hydrothermal stability of the synthesized powders, the powders for each composition were pressed into discs and then sintered at 1400-1550° C. to form dense samples with closed porosity. These samples were tested for hydrothermal stability inside a high temperature tube furnace (i.e., Keiser Rig) by being exposed to water vapor for 2000 hours at 1200° C. As shown by FIG. 8, all of the samples had minor weight change, with composition #6 showing the most negligible weight change. These results indicate that the compositions have excellent stability under water vapor containing conditions at high temperature.

The major crystalline phases of the synthesized powders as determined by X-ray diffraction (XRD) are listed in Table III below:

TABLE III
Major Crystalline Phases of Synthesized Calcium Aluminosilicates

| Composition | Major crystalline phases identified by XRD |
|---|---|
| #1 | Anorthite + alumina |
| #2 | Anorthite + mullite + alumina |
| #3 | Anorthite + mullite + alumina |
| #4 | mullite + alumina |
| #5 | Anorthite + mullite + alumina |
| #6 | Anorthite + alumina |

It is believed that the excellent hydrothermal resistance of the compositions listed above is at least partly due to their multi-phase characteristics. For example, composition #6 is made up primarily of an anorthite phase (CaAl₂Si₂O₈) and an alumina phase (Al₂O₃). Anorthite is a material with a high melting temperature and low silica activity. Alumina is a material that reduces the silica activity of the anorthite (i.e., reacts with silicon with free energy less than zero), making it less susceptible to corrosion. Thus, in general, an improved top coat 102 may include a first phase having a high melting temperature with low silica activity and a second phase that reduces the silica activity of the first phase.

The coefficients of thermal expansion (CTE) of the synthesized compositions as measured by a dilatometer are listed in Table IV below:

TABLE IV
CTE of Synthesized Calcium Aluminosilicates

CTE (10⁻⁶)

| | Instant value | Average value |
|---|---|---|
| Composition | at 1270° C. | at 1270° C. |
| #1 | 6.651 | 5.670 |
| #2 | 6.810 | 5.130 |
| #3 | 8.313 | 6.301 |
| #4 | 8.245 | 6.069 |
| #5 | 7.376 | 5.391 |
| #6 | 7.332 | 5.435 |

The following are several non-limiting examples of methods in accordance with the invention for producing bond coat slips and applying bond coats and top coats to a substrate:

### Example 1

In a first example, two bond coat slips were prepared to create an EBC with multiple bond coats. A first bond coat slip was produced by providing 50 grams of solvent comprising seventy percent by weight toluene and thirty percent by weight MEK. Liquid aHPCS in the amount of 8.56 grams was then added to the solvent and the resulting mixture was shaken by hand for two minutes. Solid aHPCS pyrolyzed at 1150° C. in the amount of 34.25 grams, silicon nitride in the amount of 31.19 grams, and zirconia media in the amount of approximately 200 grams were then added to the mixture and the resulting mixture was mixed with a paint shaker for five minutes. The resulting mixture was then processed by a ball mill for about twenty-four hours.

A second bond coat slip was produced by providing 25.75 grams of solvent comprising seventy percent by weight toluene and thirty percent by weight MEK. Liquid aHPCS in the amount of 2.73 grams was then added to the solvent and the resulting mixture was shaken by hand for two minutes. Solid aHPCS pyrolyzed at 1150° C. in the amount 8.26 grams, top coat material (i.e., anorthite+alumina) in the amount of 39.95 grams, and zirconia media in the amount of approximately 200 grams were then added to the mixture and the resulting mixture was mixed with a paint shaker for five minutes. The resulting mixture was then processed by a ball mill for about twenty-four hours.

### Example 2

In a second example, a single bond coat slip was prepared to create an EBC with a single bond coat. The bond coat slip was produced by providing 33.39 grams of solvent comprising seventy percent by weight toluene and thirty percent by weight MEK. Liquid aHPCS in the amount of 6.67 grams was then added to the solvent and the resulting mixture was shaken by hand for two minutes. Solid aHPCS pyrolyzed at 1150° C. in the amount 17.76 grams, silicon nitride in the amount of 14.66 grams, top coat material (i.e., anorthite+alumina) in the amount of 13.05 grams, and zirconia media in the amount of approximately 200 grams were then added to the mixture and the resulting mixture was mixed with a paint shaker for five minutes. The resulting mixture was then processed by a ball mill for about twenty-four hours.

### Example 3

In a third example, an EBC comprising a top coat and two bond coats was applied to a silicon nitride substrate using the bond coat slips prepared in Example 1. The edges and corners of a block-shaped silicon nitride substrate were initially rounded and the substrate cleaned with acetone. The substrate was then dip coated with the first bond coat slip with a pull out speed of two to three inches per minute. The slip was then allowed to dry overnight. The coated substrate was then fired in a tube furnace with flowing argon gas with the following schedule: 45° C./hour to 200° C. and then hold for 5 minutes, 60° C./hour to 400° C. and then hold for 1 hour, 30° C./hour to 600° C. and then hold for 30 minutes, 30° C./hour to 850° C. and then hold for 1 hour, 30° C./hour to 1150° C. and then hold for 4 hours, and 120° C./hour down to 30° C.

The coated substrate was then dip coated in the second bond coat slip with a pull out speed of two to three inches per minute. The coated substrate was then fired in a tube furnace using the same schedule used for the first bond coat slip. The substrate was then dip coated in a top coat slip with a pull out speed of two to three inches per minute and dried overnight. The coated substrate was then fired in an Instron furnace with flowing argon gas with the following schedule: 30° C./hour to 200° C. and then hold for 30 minutes, 30° C./hour to 600° C. and then hold for 1 hour, 60° C./hour to 1000° C. and then hold for 30 minutes, 60° C./hour to 1250° C. and then hold for 1 hour, and 60° C./hour down to 30° C.

### Example 4

In a fourth example, an EBC comprising a top coat and a single bond coat was applied to a silicon nitride substrate using the bond coat slip prepared in Example 2. The edges and corners of a block-shaped silicon nitride substrate were initially rounded and the substrate cleaned with acetone. The substrate was then dip coated with the bond coat slip with a pull out speed of two to three inches per minute. The slip was then dried overnight. The coated substrate was then fired in a tube furnace with flowing argon gas with the following schedule: 45° C./hour to 200° C. and then hold for 5 minutes, 60° C./hour to 400° C. and then hold for 1 hour, 30° C./hour to 600° C. and then hold for 30 minutes, 30° C./hour to 850° C. and then hold for 1 hour, 30° C./hour to 1150° C. and then hold for 4 hours, and 120° C./hour down to 30° C.

The substrate was then dip coated in a top coat slip with a pull out speed of two to three inches per minute and dried overnight. The coated substrate was then fired in an Instron furnace with flowing argon gas with the following schedule: 30° C./hour to 200° C. and then hold for 30 minutes, 30° C./hour to 600° C. and then hold for 1 hour, 60° C./hour to 1000° C. and then hold for 30 minutes, 60° C./hour to 1250° C. and then hold for 1 hour, and 60° C./hour down to 30° C.

### Example 5

In a fifth example, an EBC comprising a top coat and a single bond coat was applied to a silicon nitride substrate using a bond coat slip such as that prepared in Example 2. Unlike Example 4, however, the bond coat was sintered simultaneously with the top coat. Like the previous example, the edges and corners of a block-shaped silicon nitride substrate were initially rounded and the substrate cleaned with acetone. The substrate was then dip coated with the bond coat slip with a pull out speed of two to three inches per minute and then dried overnight. The coated substrate was then fired in a tube furnace with flowing argon gas with the following schedule: 60° C./hour to 400° C. and then hold for 1 hour, and then 120° C./hour down to 30° C.

The substrate was then dip coated in a top coat slip with a pull out speed of two to three inches per minute and dried overnight. The coated substrate was then fired in a tube furnace with flowing argon gas with the following schedule: 25° C./hour to 100° C., 5° C./hour to 300° C. and then hold for 30 minutes, 5° C./hour to 350° C. and then hold for 30 minutes, 50° C./hour to 1150° C. and then hold for 15 minutes, and 51.1° C./hour down to 25° C. The coated substrate was then fired in an Instron furnace with flowing argon gas with the following schedule: 49° C./hour to 1250° C. and then hold for 4 hours, and then 49° C./hour down to 30° C.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An article comprising:
a silicon-based ceramic substrate;
a top coat; and
a bond coat between the silicon-based ceramic substrate and the top coat, the bond coat derived from a mixture comprising a preceramic polymer precursor, a pyrolyzed preceramic polymer precursor, and a filler material selected to modify the coefficient of thermal expansion (CTE) of the bond coat to more closely match the CTE of at least one of the silicon-based ceramic substrate and the top coat.

2. The article of claim 1, wherein the preceramic polymer precursor is selected from the group consisting of polycarbosilanes, polycarbosilazanes, and silicocarbon polymers.

3. The article of claim 1, wherein the preceramic polymer precursor is a liquid.

4. The article of claim 1, wherein the pyrolyzed preceramic polymer precursor is a solid.

5. The article of claim 4, wherein the pyrolyzed preceramic polymer precursor is provided in powder form with an average particle size of less than five microns.

6. The article of claim 1, wherein the silicon-based ceramic substrate comprises a material selected from the group consisting of silicon nitride, silicon carbide, and a silicon-based ceramic matrix composite.

7. The article of claim 1, wherein the mixture further comprises an inert filler, the inert filler comprising at least one of material of the silicon-based ceramic substrate to promote adhesion to the silicon-based ceramic substrate, and material of the top coat to promote adhesion to the top coat.

8. The article of claim 1, wherein the mixture further comprises an active filler material selected to react with the preceramic polymer precursor and pyrolyzed preceramic polymer precursor to increase the volume of the bond coat material.

9. The article of claim 8, wherein the active filler material is selected from the group consisting of TiSi₂, TiH₂, Fe, Al, and Ni.

10. The article of claim 1, wherein the mixture further comprises at least one of solvents and organic additives to control the rheology of the mixture.

11. The article of claim 1, wherein the filler material comprises at least one of Al₂O₃, ZrO₂, Fe, Cu, Ni, Mo, Al, Ti, TiH₂, TiSi₂C, and MgO.

12. A bond coat slurry comprising:
a polymer preceramic precursor;
a pyrolyzed polymer preceramic precursor; and
a filler material selected to adjust the coefficient of thermal expansion of a bond coat produced from the bond coat slurry.

13. The bond coat slurry of claim 12, wherein the preceramic polymer precursor is selected from the group consisting of polycarbosilanes, polycarbosilazanes, and silicocarbon polymers.

14. The bond coat slurry of claim 12, wherein the preceramic polymer precursor is a liquid.

15. The bond coat slurry of claim 12, wherein the pyrolyzed preceramic polymer precursor is a solid.

16. The bond coat slurry of claim 15, wherein the pyrolyzed preceramic polymer precursor is a solid powder with an average particle size of less than five microns.

17. The bond coat slurry of claim 12, further comprising an inert filler material selected to promote bonding to at least one of a silicon-based ceramic substrate and a top coat.

18. The bond coat slurry of claim 12, further comprising an active filler material selected to react with the preceramic polymer precursor and pyrolyzed preceramic polymer precursor to increase the volume of the bond coat material.

19. The bond coat slurry of claim 18, wherein the active filler material is selected from the group consisting of TiSi₂, TiH₂, Fe, Al, and Ni.

20. The bond coat slurry of claim 12, further comprising at least one of solvents and organic additives to control the rheology of the bond coat slurry.

21. The article of claim 12, wherein the filler material comprises at least one of Al₂O₃, ZrO₂, Fe, Cu, Ni, Mo, Al, Ti, TiH₂, TiSi₂C, and MgO.

22. A method for applying an environmental barrier coating to a silicon-based ceramic substrate, the method comprising:
preparing a bond coat slurry, the bond coat slurry comprising a mixture containing a polymer preceramic precursor and a pyrolyzed polymer preceramic precursor;
wetting a silicon-based ceramic substrate with the bond coat slurry; and
pyrolyzing the bond coat slurry to create a bond coat on the silicon-based ceramic substrate.

23. The method of claim 22, wherein preparing a bond coat slurry comprises preparing multiple bond coat slurries for applying multiple bond coats to the silicon-based ceramic substrate.

24. The method of claim 22, further comprising wetting the bond coat with a top coat slurry.

25. The method of claim 24, wherein wetting the bond coat with a top coat slurry comprises wetting the bond coat with multiple top coat slurries to apply multiple top coats to the bond coat.

26. The method of claim 24, further comprising sintering the top coat slurry to create a top coat on the bond coat.

27. The method of claim 26, wherein pyrolyzing and sintering are conducted simultaneously.

28. The method of claim 26, wherein pyrolyzing and sintering are conducted consecutively.

29. The method of claim 26, wherein sintering comprises heating to a temperature above 1200° C.

30. The method of claim 22, wherein pyrolyzing comprises heating to a temperature below 1200° C.

31. The method of claim 22, wherein wetting comprises at least one of dip coating, spraying, painting, screen printing, and spin coating the silicon-based ceramic substrate with the bond coat slurry.
